(19) United States
(12) Patent Application Publication
(10) Pub. No.: US 2023/0146160 A1
(43) Pub. Date: May 11, 2023

(54) MACHINE TOOL

(71) Applicant: FANUC CORPORATION, Yamanashi (JP)

(72) Inventor: Chikara TANGO, Yamanashi-ken (JP)

(21) Appl. No.: 17/918,617

(22) PCT Filed: Apr. 12, 2021
(86) PCT No.: PCT/JP2021/015114

§ 371 Date: Oct. 13, 2022

(30) Foreign Application Priority Data
Apr. 17, 2020 (JP) 2020-073877

(51) Int. Cl. B23B 3/06

(52) U.S. Cl. CPC B23B 3/06

(57) ABSTRACT

Provided is a machine tool that makes it possible to prevent a reduction in accuracy of a lathe turning process. The machine tool holds a lathe turning tool by means of a tool holder attached to a main shaft and processes a workpiece placed on a rotating table with the lathe turning tool. The machine tool is provided with a fixing member (a gripping member, a pin, a plate) that comes into contact with the main shaft or the tool holder to inhibit rotation of the main shaft and the tool holder.

### TECHNICAL FIELD

The present invention relates to a machine tool that retains a lathe machining tool using a tool holder installed on a spindle, and carries out machining, by the lathe machining tool, on an object to be machined that is placed on a rotary table.

### BACKGROUND ART

JP 2018-034248 A discloses a machine tool that machines a workpiece by causing a spindle head to move relative to a table while rotating a spindle on which a cutting tool is mounted.

### SUMMARY OF THE INVENTION

It is desirable to perform a turning process using the machine tool as disclosed in JP 2018-034248 A. The machine tool that carries out the turning process rotates the workpiece while the spindle on which a lathe machining tool is installed is non-rotatably fixed by stopping the operation of a motor. However, the spindle is originally configured in a manner so as to rotate. Therefore, in the machine tool that carries out the turning process, even if the spindle is fixed by the motor, the lathe machining tool that is in contact with the workpiece at the time of the turning process can easily move in the direction of rotation of the spindle. If the lathe machining tool moves during machining, the machining accuracy decreases.

Thus, an object of the present invention is to provide a machine tool that is capable of preventing a decrease in the accuracy of a turning process.

According to an aspect of the present invention, provided is a machine tool that retains a lathe machining tool using a tool holder installed on a spindle, and carries out machining, by the lathe machining tool, on an object to be machined that is placed on a rotary table, the machine tool including a fixing member configured to come into contact with the spindle or the tool holder to thereby disable rotation of the spindle and the tool holder.

According to the present invention, it is possible to prevent the accuracy of the turning process from being decreased.

### BRIEF DESCRIPTION OF DRAWINGS

FIG. 1 is a side view showing a machine tool according to a first embodiment of the present invention;

FIG. 2 is a side view showing a portion of the machine tool according to the first embodiment;

FIG. 3 is a bottom view showing a peripheral portion of a spindle of the machine tool according to the first embodiment;

FIG. 4 is a side view showing a portion of a machine tool according to second through fourth embodiments;

FIG. 5 is a side view showing a tool holder according to the second embodiment;

FIG. 6 is a side view showing the tool holder according to the third embodiment;

FIG. 7 is a side view showing the tool holder according to the fourth embodiment;

FIG. 8 is a side view showing a portion of a machine tool according to a fifth embodiment;

FIG. 9 is a side view of the tool holder and a plate according to the fifth embodiment;

FIG. 10 shows the tool holder and the plate according to an exemplary modification of the fifth embodiment; and

FIG. 11 is a side view showing a portion of a machine tool according to an exemplary modification of the second through fourth embodiments.

### DESCRIPTION OF THE INVENTION

Preferred embodiments of a machine tool according to the present invention will be presented and described in detail below with reference to the accompanying drawings.

### First Embodiment

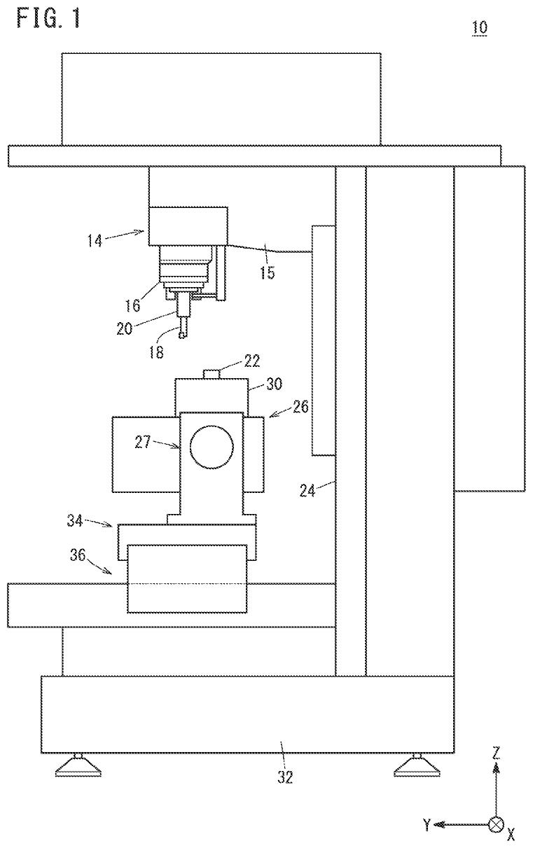

A machine tool 10 according to a first embodiment will be described with reference to the drawings. FIG. 1 is a side view showing the machine tool 10 according to the present embodiment.

The machine tool 10 carries out machining on an object to be machined 22, in other words, a workpiece, by means of a lathe machining tool 18 that is mounted on a spindle 16.

A spindle head 14 is provided on the machine tool 10. The spindle 16 is provided on the spindle head 14. A tool holder 20 for retaining the lathe machining tool 18 is detachably installed on the spindle 16.

The machine tool 10 is equipped with a column 24 that causes the spindle head 14 to move in an upper/lower direction, an additional axis device 26 that rotatably supports the object to be machined 22, and a table 34 that causes the additional axis device 26 to move in a first direction and a second direction. The spindle head 14 is supported by the column 24 via a support unit 15. The first direction and the second direction are perpendicular to each other. The first direction is a Y direction and the second direction is an X direction. Further, a direction perpendicular to the Y direction and the X direction is defined as a Z direction. A downward direction in which gravity acts is a −Z direction, and an upward direction is a +Z direction. An axial direction of the spindle 16 is in parallel with the Z direction.

The additional axis device 26 is positioned below the spindle 16. The additional axis device 26 is equipped with a rotary table 30. The object to be machined 22 is fixed on the rotary table 30. The object to be machined 22 can be fixed to the rotary table 30, for example, by suction, but the present invention is not limited to this feature. The additional axis device 26 is equipped with a tilting mechanism 27 that tilts a rotary axis of the rotary table 30. The rotary table 30 can be tilted at an arbitrary angle by the tilting mechanism 27. The rotary axes that are added by the additional axis device 26 are a rotary axis that causes the rotary table 30 to rotate, and a rotary axis that causes the rotary table 30 to be tilted. More specifically, two rotary axes are added by the additional axis device 26.

The machine tool 10 is capable of carrying out three dimensional machining on the object to be machined 22, by moving the spindle 16 in the Z direction, moving the additional axis device 26 in the X direction and the Y direction, rotating the object to be machined 22 by the additional axis device 26, and tilting the rotary table 30.

The additional axis device 26 is supported by the table 34. The table 34 is supported by a saddle 36. The table 34 is equipped with a non-illustrated X-axis movement mechanism that causes the table 34 to move in the X direction with respect to the saddle 36. Therefore, the table 34 is capable of moving in the X-axis direction with respect to the saddle 36. The saddle 36 is supported by a bed 32. The saddle 36 is equipped with a non-illustrated Y-axis movement mechanism that causes the saddle 36 to move in the Y-axis direction with respect to the bed 32. Therefore, the saddle 36 is capable of moving in the Y-axis direction with respect to the bed 32. In this manner, the table 34 is capable of moving in the X and Y directions with respect to the bed 32. Mechanisms that are widely known can be used for the Y-axis movement mechanism and the X-axis movement mechanism.

A non-illustrated splash guard is provided on the machine tool 10. The splash guard surrounds a machining area of the machine tool 10. The splash guard serves to prevent cutting fragments including cutting chips, or a cutting fluid or the like, which are generated due to machining, from being scattered into the surrounding area. A non-illustrated nozzle through which the cutting fluid is discharged toward the lathe machining tool 18 during machining is provided in the machining area. The machine tool 10 according to the present embodiment is configured in the foregoing manner.

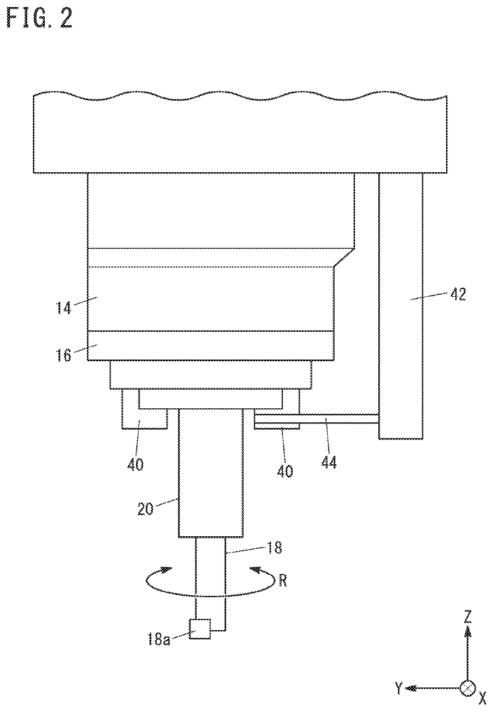

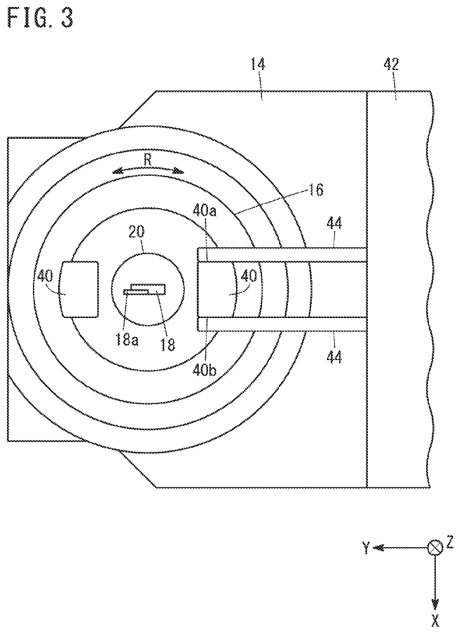

FIG. 2 is a side view showing a portion of the machine tool 10 according to the present embodiment. FIG. 3 is a bottom view showing a peripheral portion of the spindle 16 of the machine tool 10 according to the present embodiment.

The tool holder 20 retains the lathe machining tool 18 and is installed on the spindle 16. A turning tip 18a, and more specifically, a cutting edge is provided, for example, on a distal end part of the lathe machining tool 18. The spindle 16 is connected to an output shaft of a non-illustrated motor. Two spindle keys 40 that project out in the −Z direction are formed at an end of the spindle 16 in the −Z direction. The two spindle keys 40 are arranged in opposite directions with respect to the tool holder 20. The spindle 16 is stopped in a manner so that the two spindle keys 40 and the tool holder 20 are arranged alongside one another in the Y direction.

In addition to the spindle 16, a block 42 is provided on the spindle head 14. The block 42 is arranged in the −Y direction of the spindle 16 and extends in the −Z direction from the spindle head 14. The block 42 is a member disposed in parallel with the XZ plane. The block 42 includes one pair of gripping members (fixing members) 44 arranged in parallel with each other. The pair of gripping members 44 are fixed by non-illustrated bolts or the like to the block 42. The pair of gripping members 44 extend in a direction that intersects the spindle 16. An interval between one of the gripping members 44 and the other of the gripping members 44 is substantially the same as the width of the spindle key 40. The one of the gripping members 44 contacts one side surface 40a of the spindle key 40, and the other of the gripping members 44 contacts another side surface 40b of the spindle key 40. In other words, the pair of gripping members 44 grip the spindle key 40, which is arranged in close proximity to the block 42, from one and the other directions of rotation R of the spindle 16.

In the present embodiment, the pair of gripping members 44, which are connected to the spindle head 14 via the block 42, grip the spindle key 40, and thereby disable the movement of the spindle key 40 in the directions of rotation R. Upon doing so, the tool holder 20 and the lathe machining tool 18 become incapable of rotating in the directions of rotation R together with the spindle 16. Accordingly, even if the object to be machined 22 rotates during the turning process, the lathe machining tool 18 does not move. In this manner, according to the present embodiment, since the spindle 16 is firmly fixed and does not move, it is possible to prevent the accuracy of the turning process from being decreased due to a shifting in position of the lathe machining tool 18.

### Second Embodiment

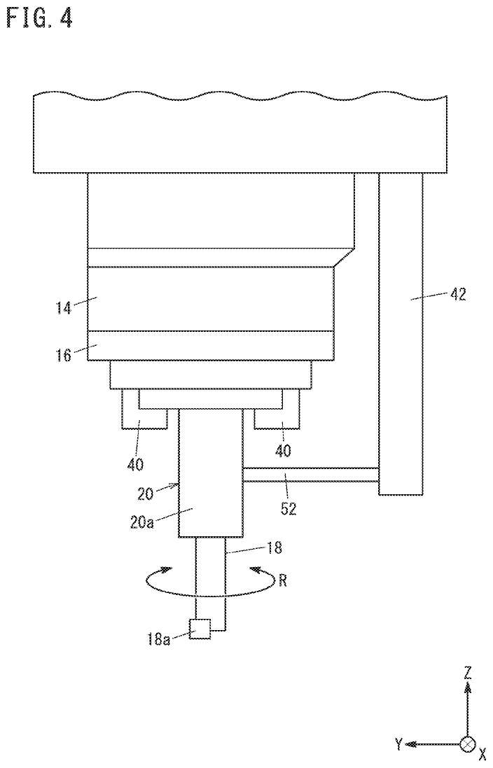

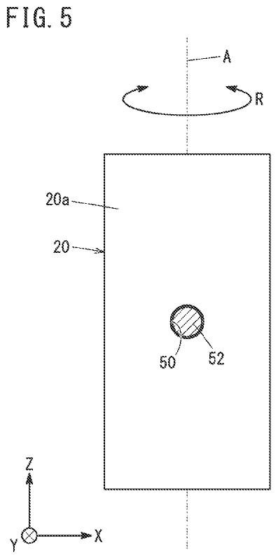

A machine tool 10 according to a second embodiment will be described with reference to FIG. 4 and FIG. 5. FIG. 4 is a side view showing a portion of the machine tool 10 according to the present embodiment. FIG. 5 is a side view showing the tool holder 20 according to the present embodiment. The same constituent elements as those of the machine tool 10 according to the first embodiment are designated by the same reference numerals, and description thereof will be omitted or referred to in an abbreviated manner.

A hole 50 serving as a concave portion (a first fitting portion) is formed in an outer peripheral surface 20a of the tool holder 20. The spindle 16 is stopped in a manner so that the hole 50 faces in a direction of the block 42, namely, the −Y direction. The block 42 is equipped with a pin (a fixing member) 52 serving as a convex portion (a second fitting portion). The pin 52 is fixed by a non-illustrated bolt or the like to the block 42. The pin 52 extends in a direction that intersects the tool holder 20. The diameter of the pin 52 and the diameter of the hole 50 are substantially the same. A distal end of the pin 52 is fitted into the hole 50. Upon doing so, the distal end of the pin 52 comes into contact with an inner circumferential surface of the hole 50.

According to the present embodiment, by the pin 52 that is connected via the block 42 to the spindle head 14 being fitted into the hole 50 of the tool holder 20, movement of the tool holder 20 in the directions of rotation R is disabled. Upon doing so, the spindle 16 and the lathe machining tool 18 become incapable of rotating in the directions of rotation R together with the tool holder 20. Accordingly, even if the object to be machined 22 rotates during the turning process, the lathe machining tool 18 does not move. In this manner, according to the present embodiment, since the tool holder 20 is firmly fixed and does not move, it is possible to prevent the accuracy of the turning process from being decreased due to a shifting in position of the lathe machining tool 18.

### Third Embodiment

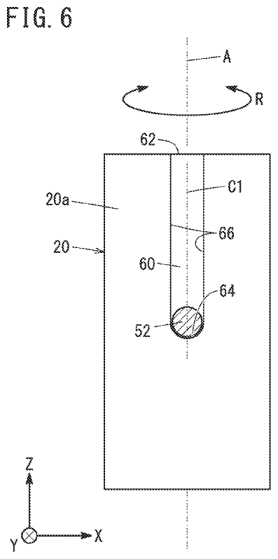

A machine tool 10 according to a third embodiment will be described with reference to FIG. 4 and FIG. 6. FIG. 6 is a side view showing the tool holder 20 according to the present embodiment. The same constituent elements as those of the machine tools 10 according to the first embodiment and the second embodiment are designated by the same reference numerals, and description thereof will be omitted or referred to in an abbreviated manner.

A groove 60 serving as a concave portion (a first fitting portion) is formed on the outer peripheral surface 20a of the tool holder 20. The spindle 16 is stopped in a manner so that the groove 60 faces in a direction of the block 42, namely, the −Y direction. The groove 60 is formed in a manner so that a centerline C1 of the groove 60 is in parallel with an axis A of the tool holder 20. The groove 60 is formed from an upper end of the tool holder 20 to substantially a central portion of the tool holder 20. An opening 62 is formed at an upper end of the groove 60, and a stop 64 is formed at a lower end of the groove 60. The opening 62 is provided in order to guide the pin 52 from the exterior to the interior of the groove 60. The diameter of the pin 52 and the width of the groove 60 are substantially the same.

The distal end of the pin 52 is fitted into the groove 60 in the following manner. In a state in which the pin 52 faces toward the axis A of the tool holder 20, the distal end of the pin 52 is inserted from above into the opening 62. Subsequently, the pin 52 or the tool holder 20 is moved in a manner so that the distal end of the pin 52 moves along the groove 60 toward the stop 64. When the distal end of the pin 52 comes into contact with the stop 64, the movement of the pin 52 or the tool holder 20 is stopped. In this state, the distal end of the pin 52 comes into contact with both inner wall surfaces 66 that face toward each other and the stop 64. For example, a non-illustrated ATC (automatic tool changer) installs the tool holder 20 on the spindle 16 from below. At this time, the distal end of the pin 52 is fitted into the groove 60.

According to the present embodiment, by the pin 52 that is connected via the block 42 to the spindle head 14 being fitted into the groove 60 of the tool holder 20, movement of the tool holder 20 in the directions of rotation R is disabled. Upon doing so, the spindle 16 and the lathe machining tool 18 become incapable of rotating in the directions of rotation R together with the tool holder 20. Accordingly, even if the object to be machined 22 rotates during the turning process, the lathe machining tool 18 does not move. In this manner, according to the present embodiment, since the tool holder 20 is firmly fixed and does not move, it is possible to prevent the accuracy of the turning process from being decreased due to a shifting in position of the lathe machining tool 18.

### Fourth Embodiment

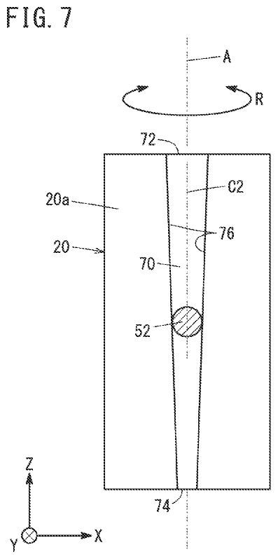

A machine tool 10 according to a fourth embodiment will be described with reference to FIG. 4 and FIG. 7. FIG. 7 is a side view showing the tool holder 20 according to the present embodiment. The same constituent elements as those of the machine tools 10 according to the first embodiment through the third embodiment are designated by the same reference numerals, and description thereof will be omitted or referred to in an abbreviated manner.

A groove 70 serving as a concave portion (a first fitting portion) is formed on the outer peripheral surface 20a of the tool holder 20. The spindle 16 is stopped in a manner so that the groove 70 faces in a direction of the block 42, namely, the −Y direction. The groove 70 is formed in a manner so that a centerline C2 of the groove 70 is in parallel with the axis A of the tool holder 20. The groove 70 is formed from an upper end of the tool holder 20 to a lower end of the tool holder 20. A first opening 72 is formed at an upper end of the groove 70, and a second opening 74 is formed at a lower end of the groove 70. The first opening 72 is provided in order to guide the pin 52 from the exterior to the interior of the groove 70. The width of the groove 70 at the first opening 72 is greater than the diameter of the pin 52. On the other hand, the width of the groove 70 at the second opening 74 is less than the diameter of the pin 52. In other words, the groove 70 is formed in a tapered shape in which an interval between inner wall surfaces 76 thereof gradually decreases from the first opening 72 toward the second opening 74.

The distal end of the pin 52 is fitted into the groove 70 in the following manner. In a state in which the pin 52 faces toward the axis A of the tool holder 20, the distal end of the pin 52 is inserted from above into the first opening 72. Subsequently, the pin 52 or the tool holder 20 is moved in a manner so that the distal end of the pin 52 moves along the groove 70 toward the second opening 74. When the distal end of the pin 52 comes into contact with both of the inner wall surfaces 76, the movement of the pin 52 or the tool holder 20 is stopped. In this state, the distal end of the pin 52 comes into contact with both of the inner wall surfaces 76 that face toward each other. For example, a non-illustrated ATC (automatic tool changer) installs the tool holder 20 on the spindle 16 from below. At this time, the distal end of the pin 52 is fitted into the groove 70.

According to the present embodiment, in the same manner as the third embodiment, it is possible to prevent the accuracy of the turning process from being decreased due to a shifting in position of the lathe machining tool 18.

### Fifth Embodiment

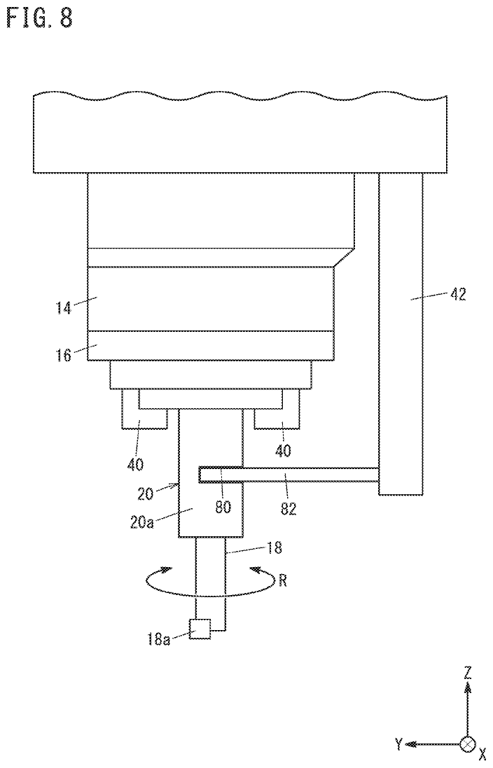

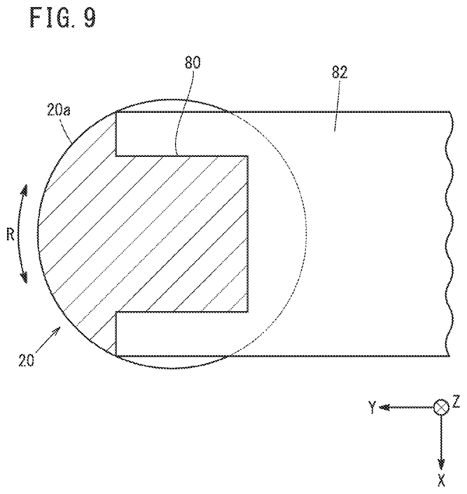

A machine tool 10 according to a fifth embodiment will be described with reference to FIG. 8 and FIG. 9. FIG. 8 is a side view showing a portion of the machine tool 10 according to the present embodiment. FIG. 9 is a side view of the tool holder 20 and a plate 82 according to the present embodiment. The same constituent elements as those of the machine tools 10 according to the first embodiment through the fourth embodiment are designated by the same reference numerals, and description thereof will be omitted or referred to in an abbreviated manner.

A groove 80 serving as a concave portion (a first fitting portion) is formed in the outer peripheral surface 20a of the tool holder 20. The spindle 16 is stopped in a manner so that the groove 80 faces in a direction of the block 42, namely, the −Y direction. The groove 80 is formed along the directions of rotation R of the tool holder 20. The groove 80 is formed in a rectangular shape in an XY cross section of the tool holder 20. The block 42 is equipped with a plate (a fixing member) 82 serving as a convex portion (a second fitting portion). The plate 82 is fixed by a non-illustrated bolt or the like to the block 42. The plate 82 extends in a direction that intersects the tool holder 20. A distal end of the plate 82 is formed in a rectangular shape that is fitted into the groove 80.

According to the present embodiment, by the plate 82 that is connected via the block 42 to the spindle head 14 being fitted into the groove 80 of the tool holder 20, movement of the tool holder 20 in the directions of rotation R is disabled. Therefore, according to the present embodiment, in the same manner as the first through fourth embodiments, it is possible to prevent the accuracy of the turning process from being decreased due to a shifting in position of the lathe machining tool 18.

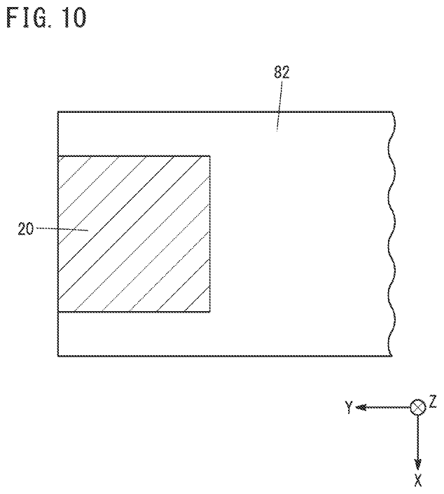

Moreover, as shown in FIG. 10, the tool holder 20 may have a prismatic shape having a rectangular XY cross section.

### Exemplary Modifications

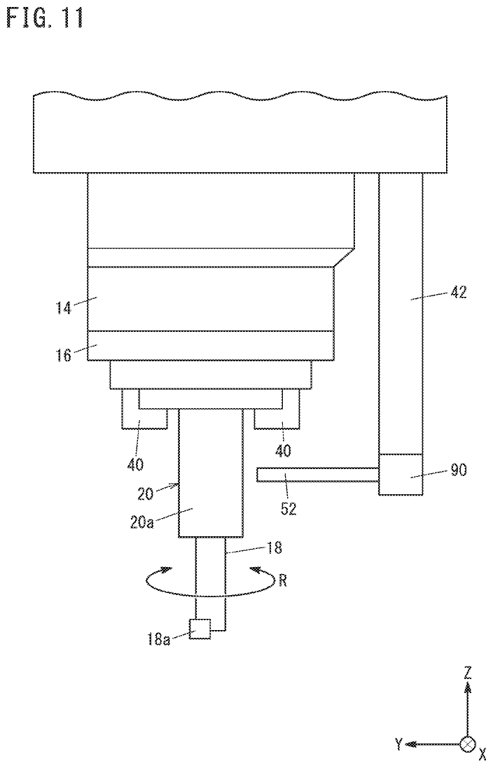

A description will be given with reference to FIG. 11 concerning the machine tool 10 according to an exemplary modification of each of the embodiments. FIG. 11 is a side view showing a portion of the machine tool 10 according to the exemplary modification of the second through fourth embodiments. The same constituent elements as those of the machine tool 10 according to the second embodiment are designated by the same reference numerals, and description thereof will be omitted or referred to in an abbreviated manner.

The block 42 supports the pin 52 via a movement mechanism 90. The movement mechanism 90 is equipped with a hydraulic or an electric drive system. By causing the pin 52 to move in a direction toward the tool holder 20 (in the Y direction in FIG. 11), the movement mechanism 90 inserts the distal end of the pin 52 into the hole 50 (see FIG. 5) or the groove 60 (see FIG. 6) or the groove 70 (see FIG. 7). Further, by causing the pin 52 to move in a direction away from the tool holder 20 (in the −Y direction in FIG. 11), the movement mechanism 90 pulls out the distal end of the pin 52 from the hole 50 (see FIG. 5) or the groove 60 (see FIG. 6) or the groove 70 (see FIG. 7).

The movement mechanism 90 is also capable of causing the gripping members 44 of the first embodiment or the plate 82 of the fifth embodiment to move in the directions toward and away from the tool holder 20.

Furthermore, various exemplary modifications may be considered in relation to the respective embodiments described above. For example, in the second to fourth embodiments described above, the tool holder 20 is formed with the concave portion and the pin 52 is formed with the convex portion. Instead of this feature, the tool holder 20 may be formed with the convex portion and the distal end of the pin 52 may be formed with the concave portion. Further, in each of the embodiments, the block 42 may be provided on the support unit 15 instead of the spindle head 14.

In the third embodiment, the groove 60 may be formed in a manner so that an interval between both of the inner wall surfaces 66 thereof gradually decreases from the outer peripheral surface 20a side toward the axis A side. Similarly, in the fourth embodiment, the groove 70 may be formed in a manner so that an interval between both of the inner wall surfaces 76 thereof gradually decreases from the outer peripheral surface 20a side toward the axis A side. In this case, the distal end of the pin 52 is preferably formed in a tapered shape.

### Inventions that can be Obtained from the Embodiments

The inventions that are capable of being grasped from the above-described embodiments will be described below.

The aspect of the present invention is characterized by the machine tool (10) that retains the lathe machining tool (18) using the tool holder (20) installed on the spindle (16), and that carries out machining, by the lathe machining tool, on the object to be machined (22) that is placed on the rotary table (30), the machine tool including the fixing member (44, 52, 82) that comes into contact with the spindle or the tool holder to thereby disable rotation of the spindle and the tool holder.

In the aspect of the present invention, there may further be provided the spindle head (14) equipped with the spindle, and the block (42) fixed to the spindle head, wherein the fixing member may extend from the block in a direction intersecting the spindle.

In the aspect of the present invention, there may further be provided the spindle key (40) that projects out from a portion of the spindle toward the side of the lathe machining tool, wherein the fixing member may disable rotation of the spindle by gripping the spindle key from one direction of rotation (R) and another direction of rotation (R) of the spindle.

In the aspect of the present invention, the tool holder may include the first fitting portion (50, 60, 70, 80), the fixing member may include the second fitting portion (52, 82), and rotation of the tool holder may be disabled by the first fitting portion and the second fitting portion being fitted to each other.

In the aspect of the present invention, the first fitting portion may be the concave portion (50, 60, 70, 80) formed on the outer peripheral surface (20a) of the tool holder, and the second fitting portion may be the convex portion (52, 82) formed at the distal end of the fixing member.

In the aspect of the present invention, the concave portion may be the hole (50), and the convex portion may be the pin (52).

In the aspect of the present invention, there may further be provided the movement mechanism (90) that causes the fixing member to move in directions toward and away from the tool holder.

In the aspect of the present invention, the concave portion may be the groove (60, 70) that is formed in parallel with the axis (A) of the tool holder, and the convex portion may be the pin (52).

In the aspect of the present invention, the groove may be open on the side of the lathe machining tool.

In the aspect of the present invention, the groove may be closed on the side of the spindle, and the pin may come into contact with the spindle side end part (64) of the groove.

In the aspect of the present invention, the groove may be formed in a tapered shape in which the width thereof gradually narrows from the side of the spindle toward the side of the lathe machining tool, and the pin may come into contact with the inner wall surfaces (76) of the groove.

It should be noted that the machine tool according to the present invention is not limited to the embodiments described above and the exemplary modifications thereof, and it is a matter of course that various configurations could be adopted therein without departing from the essence and gist of the present invention.

1. A machine tool that retains a lathe machining tool using a tool holder installed on a spindle, and carries out machining, by the lathe machining tool, on an object to be machined that is placed on a rotary table, the machine tool comprising:
a fixing member configured to come into contact with the spindle or the tool holder to thereby disable rotation of the spindle and the tool holder.

2. The machine tool according to claim 1, further comprising:
a spindle head equipped with the spindle; and
a block fixed to the spindle head,
wherein the fixing member extends from the block in a direction intersecting the spindle.

3. The machine tool according to claim 1, further comprising a spindle key configured to project out from a portion of the spindle toward a side of the lathe machining tool,
wherein the fixing member disables rotation of the spindle by gripping the spindle key from one direction of rotation and another direction of rotation of the spindle.

4. The machine tool according to claim 1, wherein:
the tool holder includes a first fitting portion;
the fixing member includes a second fitting portion; and
rotation of the tool holder is disabled by the first fitting portion and the second fitting portion being fitted to each other.

5. The machine tool according to claim 4, wherein:
the first fitting portion is a concave portion that is formed in an outer peripheral surface of the tool holder; and
the second fitting portion is a convex portion formed at a distal end of the fixing member.

6. The machine tool according to claim 5, wherein:
the concave portion is a hole; and
the convex portion is a pin.

7. The machine tool according to claim 5, further comprising a movement mechanism configured to cause the fixing member to move in directions toward and away from the tool holder.

8. The machine tool according to claim 5, wherein:
the concave portion is a groove that is formed in parallel with an axis of the tool holder; and
the convex portion is a pin.

9. The machine tool according to claim 8, wherein
the groove is open on a side of the lathe machining tool.

10. The machine tool according to claim 9, wherein:
the groove is closed on a side of the spindle; and
the pin comes into contact with a spindle side end part of the groove.

11. The machine tool according to claim 9, wherein:
the groove is formed in a tapered shape in which a width thereof gradually narrows from the side of the spindle toward the side of the lathe machining tool; and
the pin comes into contact with an inner wall surface of the groove.
